(19) United States
(12) Patent Application Publication
(10) Pub. No.: US 2024/0383550 A1
(43) Pub. Date: Nov. 21, 2024

(54) TRAVELING DEVICE

(71) Applicant: Isuzu Motors Limited, Yokohama-shi (JP)

(72) Inventor: Muneyuki OSAWA, Kanagawa (JP)

(73) Assignee: Isuzu Motors Limited, Yokohama-shi (JP)

(21) Appl. No.: 18/664,338

(22) Filed: May 15, 2024

(30) Foreign Application Priority Data
May 16, 2023 (JP) 2023-080857

(51) Int. Cl. B62D 63/04

(52) U.S. Cl. CPC B62D 63/04

(57) ABSTRACT

An object of the present disclosure is, in a traveling device including omnidirectional wheels with suspension, to always maintain the posture of the traveling device main body in a constant state without tilting the main body with respect to a travel floor surface. The traveling device includes a placing part where a cargo is placed, and an omnidirectional wheel provided on the placing part via a suspension to be vertically movable relative to the placing part. The suspension, in an unloaded state in which no cargo is placed, presses the omnidirectional wheel against a travel floor surface, and the suspension includes a stopper that limits a relative distance between the placing part and the omnidirectional wheel so that the relative distance does not become smaller than a distance between the placing part and the omnidirectional wheel in the unloaded state.

### CROSS REFERENCE TO RELATED APPLICATIONS

This application claims the benefit of priority of Japanese Patent Application No. 2023-080857, filed on May 16, 2023, the contents of which are incorporated by reference as if fully set forth herein in their entirety.

### TECHNICAL FIELD

The present disclosure relates to a traveling device with omnidirectional wheels.

### BACKGROUND ART

Traveling devices that are equipped with omnidirectional wheels such as mecanum wheels or omni wheels and are movable in all directions have been known. Such a traveling device includes a traveling device main body, a plurality of omnidirectional wheels (typically four wheels) provided on the traveling device main body, drive devices that independently drive omnidirectional wheels, and a control device that controls the drive devices. By independently controlling the drive of each omnidirectional wheel, the traveling device can be moved in any direction such as front, back, left, right, or diagonal direction, or in various other ways, such as turning.

When a travel floor surface (namely, floor surface on which a traveling device travels) is uneven, some of the plurality of omnidirectional wheels may be separated from the travel floor surface, which may cause the traveling device to travel in an unexpected direction, making the traveling unstable. For this problem, the following is proposed. Omnidirectional wheels are provided on the traveling device body via a suspension, thereby allowing the omnidirectional wheels to be moved up and down relative to the traveling device main body. The omnidirectional wheels thus follow the unevenness of the travel floor surface, allowing all omnidirectional wheels to always maintain contact with the travel floor surface (for example, Patent Literature (hereinafter, referred to as PTL) 1).

In addition, it is conceivable to provide the traveling device with a sensor such as a light detection and ranging (Lidar) sensor to control the autonomous travel while obtaining the situation around the traveling device. The traveling device compares information on the map and obstacles given in advance with information on obstacles and the like around the traveling device detected and measured by the sensor, and autonomously travels along a predetermined route while obtaining the position of the own vehicle.

### CITATION LIST

### Patent Literature

### PTL 1

Japanese Patent Application Laid-Open No. 2020-189564

### SUMMARY OF INVENTION

### Technical Problem

In the traveling device described in PLT 1, the amount of contraction of each suspension changes depending on the presence or absence of a cargo to be transported or the weight of the cargo, thereby changing the vehicle height. In addition, when the loads acting on respective suspensions differ from each other (becomes uneven) due to cargo or the like, the posture of the traveling device main body may be tilted. When the posture of the traveling device main body is tilted, the weight balance of the traveling device may become lost and traveling may become unstable. In addition, when the traveling device main body is provided with a sensor for autonomous travel, the following may occur: when the vehicle height or posture of the traveling device changes, the height or measurement axis of the sensor installed in the traveling device main body changes, causing errors in the measurement results regarding obstacles and the like around the traveling device.

An object of the present disclosure is to provide a traveling device including omnidirectional wheels with suspensions. The traveling device is capable of always maintaining the vehicle height and posture of the traveling device main body in a constant state without tilting the traveling device main body with respect to a travel floor surface.

### Solution to Problem

In order to achieve the above object, the traveling device according to the present disclosure includes: a placing part on which a cargo is to be placed; and an omnidirectional wheel that is provided on the placing part via a suspension to be vertically movable relative to the placing part. In the traveling device, the suspension, in an unloaded state in which no cargo is placed, presses the omnidirectional wheel against a travel floor surface, and the suspension includes a stopper that limits a relative distance between the placing part and the omnidirectional wheel so that the relative distance does not become smaller than a distance between the placing part and the omnidirectional wheel in the unloaded state.

The traveling device of the present disclosure further includes a sensor that measures a situation around the traveling device.

In addition, in the traveling device of the present disclosure, the suspension includes a support member that rotatably supports the omnidirectional wheel, a coupling mechanism that couples the support member to a main body of the traveling device in a movable manner relative to the main body, and an urging member that urges the support member in a direction away from the main body; and the stopper is a stopper member that is provided on the support member and that comes into contact with the main body.

### Advantageous Effects of Invention

According to the present disclosure, as the stopper of a suspension is constantly in contact with the traveling device main body, the posture of the traveling device main body with respect to a travel floor surface is maintained in a constant state.

### BRIEF DESCRIPTION OF DRAWINGS

FIG. 1 is a side view illustrating a traveling device according to an embodiment of the present disclosure;

FIG. 2 is a side view illustrating details of a traveling part;

FIG. 3 is a side view illustrating another embodiment of the traveling part; and

FIG. 4 is a side view illustrating another embodiment of the traveling device.

### DESCRIPTION OF EMBODIMENTS

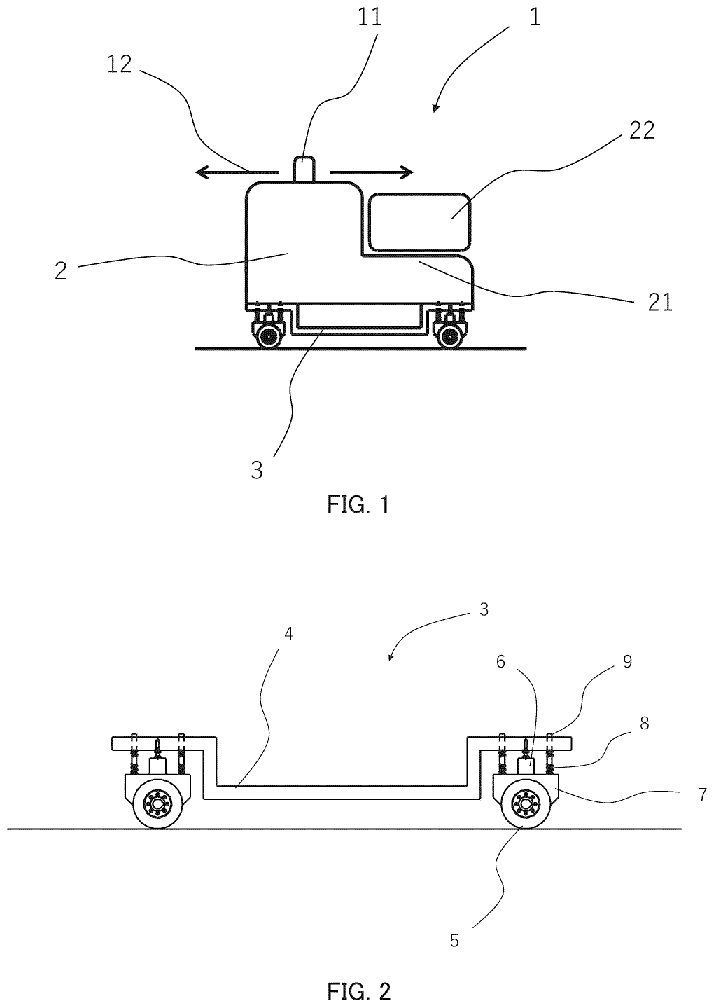

Hereinafter, embodiments of the present disclosure will be described with reference to the drawings. FIG. 1 is a side view schematically illustrating traveling device 1 according to an embodiment of the present disclosure. Traveling device 1 includes traveling device main body 2 and traveling part 3. Traveling device main body 2 is provided with placing part 21 on which cargo 22 is to be placed.

Placing part 21 is a loading platform on which cargo 22 to be carried by traveling device 1 is placed, and is provided in the front section of traveling device main body 2. In addition to the loading platform illustrated in FIG. 1, placing part 21 may also include a cargo handling device such as a forklift or a robot hand. The location where placing part 21 is provided is not limited to the front section of traveling device main body 2, but may also be in the rear, side, or the entire upper section of traveling device main body 2.

Lidar device 11 is provided at the upper section of traveling device main body 2 as an example of a sensor for detecting objects such as obstacles and the like around traveling device 1. Lidar device 11 measures the distance from Lidar device 11 to an object in the surroundings of traveling device 1 by emitting laser light 12 toward the surroundings and detecting the light reflected from the object. Providing Lidar device 11 on the upper section of traveling device main body 2 allows measurement of the distance to the object in the surroundings without being affected by cargo 22 placed on placing part 21. Traveling device 1 autonomously travels to the destination while obtaining the current position of traveling device 1 by comparing the distance to the object measured by Lidar device 11 to the map information of the traveling area stored in advance.

FIG. 2 illustrates details of traveling part 3. Traveling part 3 includes chassis 4 and four mecanum wheels 5 as omnidirectional wheels. Mecanum wheels 5 are provided at the four corners of chassis 4 via suspensions. More specifically, mecanum wheels 5 are rotatably supported by support members 7, and are rotationally driven by motors (not illustrated) attached to the mecanum wheels, respectively. Support member 7 is provided with a plurality of guide members 9 (corresponding to an example of a coupling mechanism), and support member 7 is supported by guide members 9 so as to be vertically movable with respect to chassis 4. In addition, each of guide members 9 is provided with coil-shaped spring 8 as an urging member, and due to support member 7 being attached to chassis 4 via spring 8, support member 7 is urged in a direction away from chassis 4.

Stopper member 6 is provided on support member 7 to protrude toward chassis 4. The initial length and spring constant of spring 8 are selected so that spring 8 contracts due to the weight of the traveling device main body even in an unloaded state, in which no cargo is placed, thereby allowing stopper member 6 to come into contact with chassis 4.

In the following, the operations and effects of traveling device 1 of the present embodiment will be described. In traveling device 1 of the present embodiment, even in an unloaded state, in which no cargo is placed, stopper member 6 is in contact with chassis 4, thereby limiting the approach of mecanum wheel 5 to chassis 4. As a result, spring 8 does not contract when a cargo is placed, and therefore, the height and posture of traveling device main body 2 are always constant, and even when the load on traveling device main body 2 is offset from the center during the transportation of the cargo, traveling device main body 2 does not tilt and the traveling becomes stable, thereby preventing errors from occurring in measurements by Lidar device 11.

In addition, mecanum wheels 5 are provided on traveling device main body 2 via suspensions, and therefore, mecanum wheels 5 do not leave a travel floor surface even when the travel floor surface is uneven, thereby preventing traveling device 1 from making unexpected moves. When mecanum wheel 5 runs over unevenness on the travel floor surface, traveling device main body 2 may be temporarily tilted, but this inclination is temporary and returns to its original state once mecanum wheel 5 pass over the unevenness. This inclination is thus recognized as a temporary error in the measurement of distances to surrounding objects by Lidar device 11, and the autonomous traveling of traveling device 1 continues without any problem.

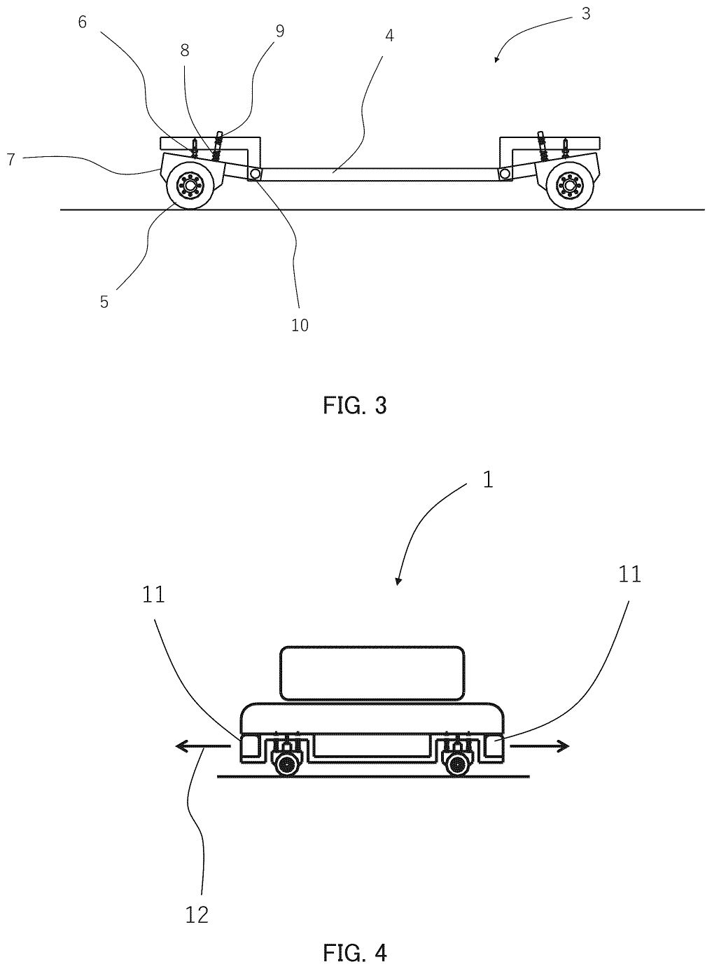

FIG. 3 illustrates another embodiment of traveling part 3. In this example, each of support members 7 rotatably supporting mecanum wheel 5 is turnably provided to chassis 4 via turn shaft 10. In addition, spring 8 is provided between support member 7 and chassis 4 to urge support member 7 in a direction away from chassis 4. This structure allows the attachment structure of support member 7 to chassis 4 to be simplified, and therefore, mecanum wheels 5 can more smoothly follow the unevenness of a travel floor surface.

FIG. 4 illustrates another embodiment of traveling device 1. In this example, two Lidar devices 11, 11 are provided below traveling device main body 2 in the front and rear sections, respectively. When the following are required, for example, to lower the loading platform, to keep the center of gravity of traveling device 1 low, and/or to keep the vehicle height low due to spatial constraints in the traveling area, it is also possible to provide Lidar devices 11, 11 at lower positions of traveling device main body 2 as in this example. In this case, in order to thoroughly measure the surroundings of traveling device 1, it is desirable to provide a plurality of (two or three or more) Lidar devices 11, 11.

In the present invention, the structure of the suspension that supports the mecanum wheel is not limited to the above example, and various structures may be adopted. Furthermore, although the above example has been described assuming that the omnidirectional wheel is a mecanum wheel; however, the same effect can naturally be obtained even when other types of omnidirectional wheels such as an omni wheel are used in place of the mecanum wheel.

### INDUSTRIAL APPLICABILITY

The present disclosure is suitably utilized for traveling devices including omnidirectional wheels with suspensions.

### REFERENCE SIGNS LIST

1 Traveling device
2 Traveling device main body
3 Traveling part
4 Chassis
5 Mecanum wheel
6 Stopper member
7 Support member
8 Spring
9 Guide member
10 Turn shaft
11 Lidar device
12 Laser light
21 Placing part
22 Cargo

1. A traveling device, comprising:
a placing part on which a cargo is to be placed; and
an omnidirectional wheel that is provided on the placing part via a suspension to be vertically movable relative to the placing part, wherein
the suspension, in an unloaded state in which no cargo is placed, presses the omnidirectional wheel against a travel floor surface, and the suspension includes a stopper that limits a relative distance between the placing part and the omnidirectional wheel so that the relative distance does not become smaller than a distance between the placing part and the omnidirectional wheel in the unloaded state.

2. The traveling device according to claim 1, further comprising:
a sensor that measures a situation around the traveling device.

3. The traveling device according to claim 1, wherein:
the suspension includes a support member that rotatably supports the omnidirectional wheel, a coupling mechanism that couples the support member to a main body of the traveling device in a movable manner relative to the main body, and an urging member that urges the support member in a direction away from the main body; and
the stopper is a stopper member that is provided on the support member and that comes into contact with the main body.
